(19) United States
(12) Patent Application Publication
(10) Pub. No.: US 2009/0145277 A1
(43) Pub. Date: Jun. 11, 2009

(54) PAPER CUTTER WITH CUTTING LINE GUIDE

(76) Inventor: Humberto Rodriguez, Wabash, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/332,078

(22) Filed: Dec. 10, 2008

Related U.S. Application Data
(60) Provisional application No. 61/012,648, filed on Dec. 10, 2007.
(60) Provisional application No. 61/108,709, filed on Oct. 27, 2008.
(60) Provisional application No. 61/108,712, filed on Oct. 27, 2008.

(51) Int. Cl. B26D 7/02

(52) U.S. Cl. 83/455

(57) ABSTRACT

A trimmer apparatus comprises a base having a top surface, a cutting assembly engaged with the base, and a flexible and resilient line guide. The cutting assembly includes a blade moveable with respect to the base along a cutting path. Additionally, the line guide is coupled to the base or the cutting assembly and positioned along the cutting path to provide a visual indication of the cutting path of the blade. The trimmer apparatus may be a rotary or guillotine style trimmer.

### CROSS-REFERENCE TO RELATED APPLICATIONS

The present application claims the benefit of U.S. Provisional Application No. 61/012,648, filed Dec. 10, 2007, U.S. Provisional Application No. 61/108,709, filed Oct. 27, 2008, and U.S. Provisional Application No. 61/108,712, filed Oct. 27, 2008, all of which are hereby incorporated by reference in their entireties.

### FIELD OF THE DISCLOSURE

The present disclosure is directed to cutting and trimming devices, and in particular rotary and guillotine trimmers.

### BACKGROUND OF THE DISCLOSURE

Trimmers are often used to cut paper and other sheet materials such as cardboard, leather, fabric, plastics, film and similar materials. Typically in a rotary trimmer, a sharpened circular blade is mounted in a housing and held perpendicular to a cutting board. A paper is placed between the housing and the cutting board. The housing is then rolled across the cutting board to cut or trim the paper. In some arrangements the housing is depressed to move the blade toward the board to engage the blade with the paper.

In the past, rotary trimmers have required that the blade be spaced apart from a mounting rail or guide to prevent the blade from touching or being interfered with by the guide. This spacing leads to imprecision regarding placement of the sheet material relative to the precise cutting line when the paper or other material is positioned on the cutting board.

A typical guillotine style trimmer includes a sharpened blade pivotally mounted adjacent the edge of a cutting board. The material to be cut is placed on the cutting board, extending over the edge with a desired cut line aligned with the blade. The guillotine blade is then pivoted downward adjacent the board edge so that the blade cuts as the blade is lowered. As with typical rotary trimmers, typical guillotine trimmers lead to imprecision in the cutting line due to the inability to align the paper as desired along the precise cutting line of the guillotine blade.

Additionally, if an angled cut is desired, typical rotary style trimmers require that the user manipulate the material to a desired angle with respect to the fixed cutting path of the blade. This can lead to imprecision regarding placement of the material relative to the precise cutting line when the paper or other material is positioned on the cutting board.

An improved trimmer is desired.

Objects and attendant advantages of the disclosure will be readily appreciated as the same become more clearly understood by references to the following detailed description when considered in connection with the accompanying drawings in which like reference numerals designate like parts throughout the figures thereof.

### SUMMARY OF THE DISCLOSURE

In certain embodiments, a rotary trimmer apparatus comprises a base, a bracket engaged with the base, a trimmer assembly engaged with the bracket, and a line guide portion engaged with the bracket. The bracket includes two parallel side rails defining a central cutting slot between the rails, the bracket being spaced above the base to define a gap therebetween to allow material to be inserted into the gap. The trimmer assembly is slideable along the side rails and includes a cutting blade extending down into the central cutting slot to cut material positioned in the gap. Additionally, the line guide portion extends along the central cutting slot between the rails to indicate the cutting path of the cutting blade.

In certain other embodiments, a trimmer apparatus comprises a base, a cutting assembly engaged with the base, and a flexible and resilient line guide. The cutting assembly includes a blade moveable with respect to the base along a cutting path. Additionally, the line guide is coupled to the base or the cutting assembly and positioned along the cutting path to provide a visual indication of the cutting path of the blade.

In certain other embodiments, a rotary trimmer apparatus having a movable cutting path comprises a base having a top cutting surface and first and second opposing longitudinal sides, a moveable cutting path assembly engaged with the base, and a trimmer assembly engaged with the moveable cutting path assembly. The moveable cutting path assembly includes a first end portion moveable adjacent and parallel to the first longitudinal side and a second end portion moveable adjacent and parallel to the second longitudinal side, the end portions being movable independent of each other. Additionally, the moveable cutting path assembly includes at least one guide rail extending at least partially between the end portions, the at least one guide rail being spaced above the top cutting surface to define a gap therebetween to allow material to be inserted into the gap. The trimmer assembly is slideable along the at least one guide rail and includes a cutting blade to cut material received in the gap along a cutting path. Movement of at least one of the end portions causes the at least one guide rail to move above the cutting surface, thereby moving the cutting path of the cutting blade.

### BRIEF DESCRIPTION OF THE DRAWINGS

FIG. 1 is a perspective view of a rotary trimmer according to one embodiment of the present disclosure.

FIG. 2 is a top view of the embodiment of FIG. 1.

FIG. 3 is a view of one end of the cutting assembly according to the embodiment of FIG. 1.

FIG. 4 is a perspective view of the underside of one end of the cutting assembly illustrated in FIG. 1.

FIG. 5 is a view of one end of the cutting assembly illustrated in FIG. 1, including a blade profile and omitting the handle assembly.

FIG. 6 is a perspective view of a guillotine trimmer according to one embodiment of the present disclosure.

FIG. 7 is a close-up view of a portion of the guillotine trimmer according to the embodiment of FIG. 6.

FIG. 8 is a perspective view of a guillotine trimmer according to one embodiment of the present disclosure.

FIG. 9 is a perspective view of a prior art rotary style trimmer.

FIG. 10 is a perspective view of a trimmer according to one embodiment of the present disclosure.

FIG. 11 is a close-up perspective view of a portion of the trimmer according to the embodiment illustrated in FIG. 10.

FIG. 12 is a close-up perspective view of another portion of the trimmer according to the embodiment illustrated in FIG. 10.

### DESCRIPTION OF THE ILLUSTRATED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles of the disclosure being contemplated as would normally occur to one skilled in the art to which the disclosure relates.

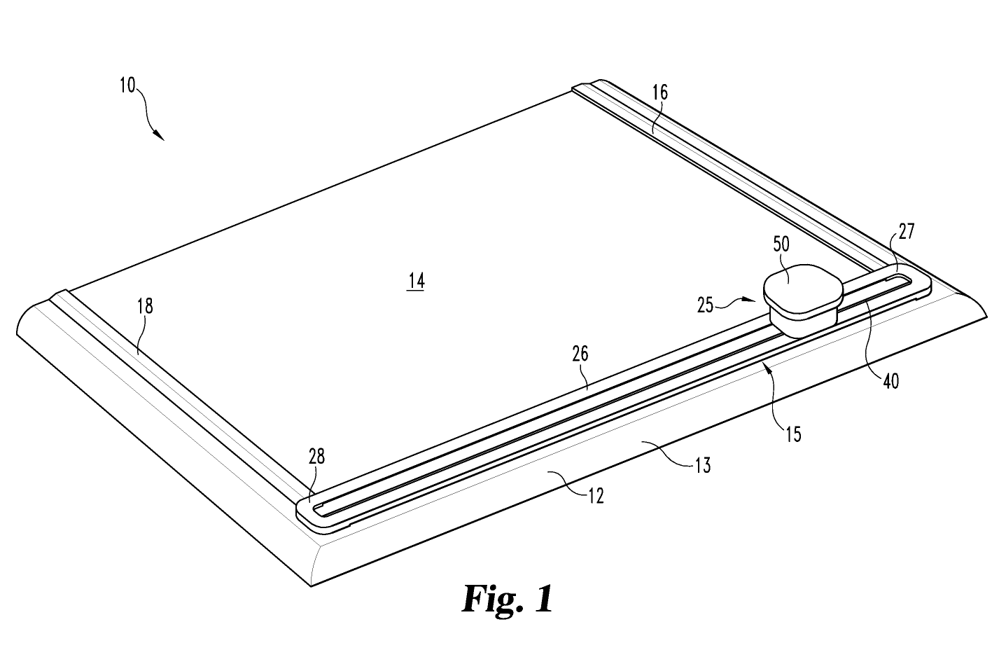

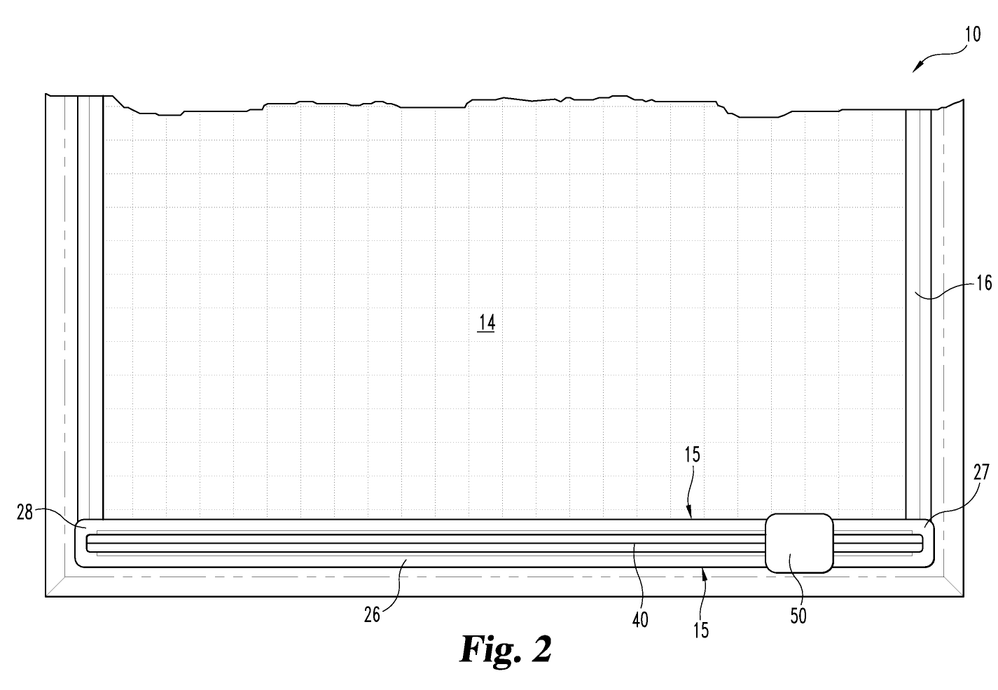

Certain embodiments of the present disclosure provide a rotary trimmer with a line guide visible during use, which allows a user to precisely align a desired cut line in a material, such as paper, with a cutting path of the rotary trimmer. In general, a rotary trimmer 10 is illustrated in FIGS. 1 and 2, including a base 12 with a cutting surface 14 upon which a material to be cut is arranged and an edge 13. The material to be cut is placed in a slot or paper path 15 between cutting surface 14 and a cutting assembly 25. The material is preferably arranged between the top end 16 of the cutting surface and a bottom end 18.

Cutting assembly 25 includes a bracket 26 and a trimmer assembly 50. Bracket 26 preferably has a top end 27 mounted to the top end 16 of trimmer 10 and bracket 26 has a bottom or lower end 28 mounted to lower end 18 of trimmer 10, the bracket 26 being longitudinally-oriented adjacent edge 13. Paper path 15 is defined between cutting surface 14 and the lower side of bracket 26. Trimmer assembly 50 is preferably mounted to bracket 26 and allowed to slidably reciprocate between the top and bottom ends of bracket 26 as desired. In certain embodiments, trimmer assembly 50 is a blade housing from which a rotary blade extends. In use, trimmer assembly 50 is pressed downward by the user to clamp the paper or cutting material between bracket 26 and cutting surface 14 while the trimmer assembly is slid along bracket 26 to the desired end of the cut. A self-healing strip (not visible) may be recessed in the base 12 to receive the lower edge of the blade during cutting.

In certain embodiments of the present disclosure, cutting assembly 25 includes a line guide 40. Line guide 40 is mounted to bracket 26 and extends over paper path 15 so that the line guide 40 is visible over the material to be cut just prior to the cutting action.

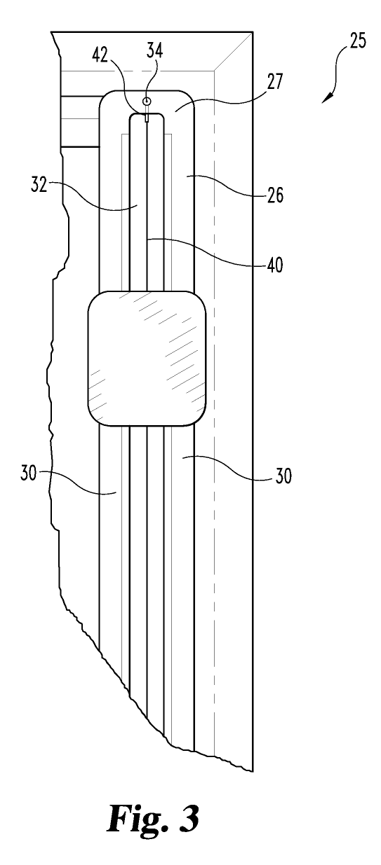

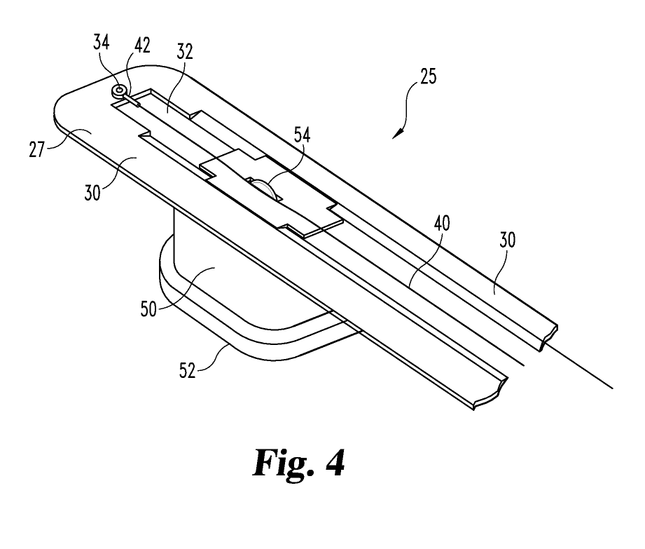

End views of cutting assembly 25 according to certain preferred embodiments of the present disclosure are illustrated in FIGS. 3 and 4. Top end 27 is illustrated for convenience, while bottom end 28 is symmetric. As illustrated, bracket 26 includes two substantially laterally rigid side or guide rails 30 defining a cutting slot 32 between them. In certain embodiments, the side rails 30 are parallel. Alternatively, the bracket 26 could include a single rail on which the cutting assembly 25 slideably reciprocates. Line guide 40 extends longitudinally along the bracket within the slot and is mounted to bracket 26. One example of a mounting is a connector 42 with an eyelet mounted over a connector pin 34 on bracket 26 and a clamp holding the line guide material. Trimmer assembly 50 is preferably mounted to bracket 26 with a blade 54 extending from slot 32 and adjacent line guide 40. Trimmer assembly 50 includes a handle portion 52 to be pressed downward and pushed along the bracket by the user.

In certain preferred embodiments, the line guide 40 extends longitudinally within slot 32 to indicate the cutting path of blade 54. In certain embodiments, the line guide 40 is spaced with gaps between it and side rails 30. Blade 54 is spaced between the side rails as well. The line guide 40 can be considered independent from the side rails, defining a “floating” line.

In alternate embodiments, line guide 40 may float over the paper with one rail or without rails so that the line guide is not part of or near a rigid rail type portion. In such embodiments, alternate mounting systems will be needed to hold and guide the trimmer assembly.

Trimmer assembly 50 is illustrated with a circular rotary blade with a straight edge for clarity; however, alternate blades can optionally be used instead. Examples include patterned, scalloped, pinking, waved, perforating or zigzag edged blades. In certain embodiments, trimmer assembly 50 can allow for ease of changing a desired blade in use. In one embodiment, handle 50 may include a push button assembly to alternately select one of two available blades, while in other embodiments two or more blades may be available to be selectively engaged. In a still further embodiment, handle 50 may allow for mounting of a blade cassette to interchangeably mount cassettes with different blades. As an optional feature, base 12 and bracket rails 30 can optionally be marked with alignment lines and or measurements to assist in placing material to be cut. Such lines are not illustrated herein to facilitate ease of understanding the disclosure.

Other embodiments of the present disclosure provide a guillotine style trimmer with a line guide visible during use, which allows a user to precisely align a desired cut line in a material, such as paper, with a cutting path of the trimmer blade. In a guillotine style trimmer, a sharpened blade is pivotally mounted adjacent the edge of a cutting board. The material to be cut is placed on the cutting board, extending over the edge with a desired cut line aligned with the blade. The guillotine blade is then pivoted downward adjacent the board edge so that the blade cuts as the blade is lowered. A clamp to hold the paper and safety guides to prevent injury can be included, but are not necessary.

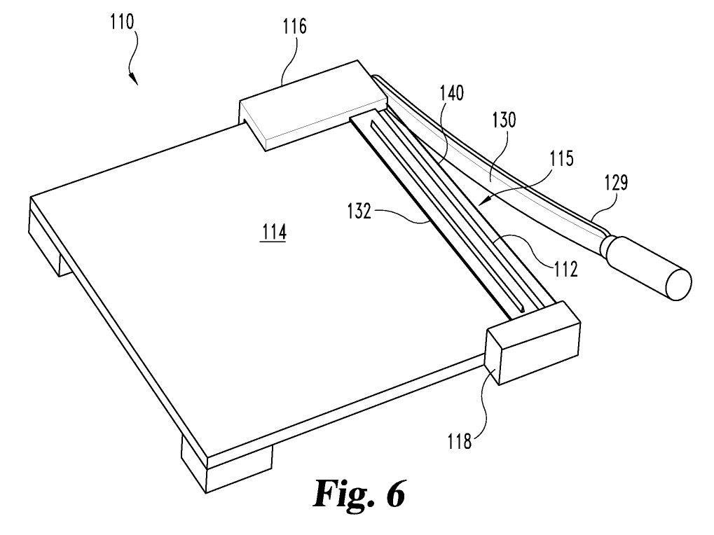

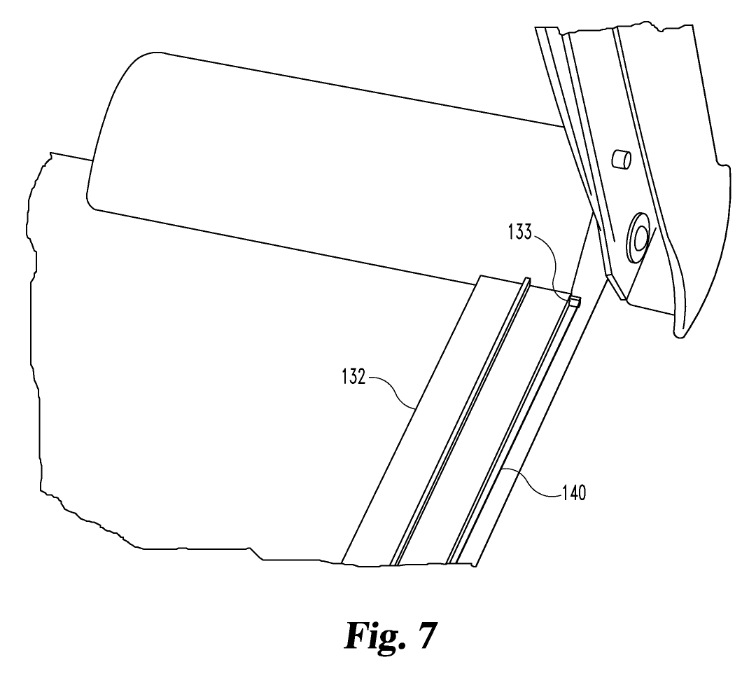

FIGS. 6-7 illustrate a guillotine trimmer 110, including a cutting board or base 112 having a top surface 114 upon which a material to be cut is arranged and a cutting assembly with a guillotine handle 129 carrying a guillotine cutting blade 130. Trimmer 110 includes a top end 116, a bottom end 118 and a safety guard 132 to prevent injury extending therebetween. The material to be cut is placed in a slot or paper path 115 between surface 114 and guard 132, preferably between the top and bottom ends 116 and 118, respectively. In the illustrated embodiment, trimmer 110 does not include a clamp to hold the paper; however, it should be appreciated that a conventional clamp could optionally be included on trimmer 110 as desired.

Guillotine trimmer 110 also includes a line guide 140. Line guide 140 extends longitudinally between top and bottom ends 116 and 118 over paper path 115, so that the line guide 140 is visible over the material to be cut just prior to the cutting action. Line guide 140 is spaced above surface 114, such that material can be positioned underneath line guide 140 in paper path 115. Additionally, line guide 140 extends just slightly beyond and/or is offset from base 112, along the cutting path of blade 130. In the illustrated embodiment, ends of line guide 140 are arranged between ends 116 and 118. As illustrated, guard 132 includes top and bottom extension portions 133 adjacent ends 116 and 118 which function to align line guide 140 along the cutting path. It should be appreciated that line guide 140 could be mounted to trimmer 110 in various other appropriate manners as would occur to one skilled in the art.

Additional embodiments of the present disclosure provide a rotary trimmer with a moveable cutting path which can be positioned as desired by the user, such that the trimmer provides cutting angle adjustability. In certain embodiments, the ends of the cutting path are configured to translate along the sides of the cutting board to create various cutting path angles with respect to the sides. The trimmer may also include a line guide visible during use, which allows a user to precisely align a desired cut line in a material, such as paper, with a cutting path of the rotary trimmer.

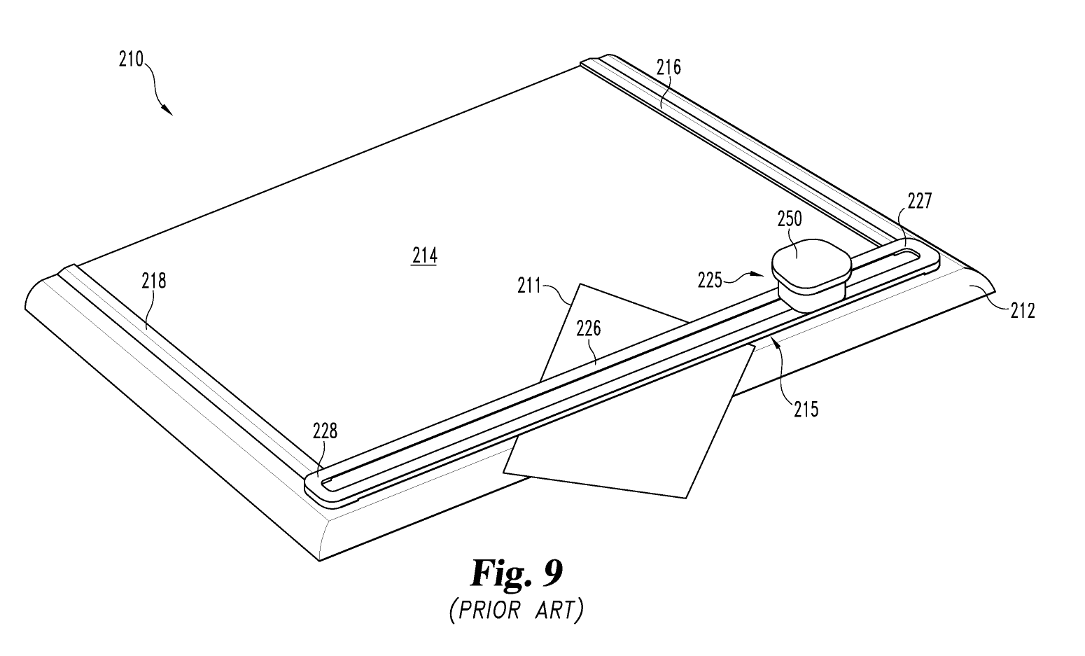

FIG. 9 illustrates a prior art rotary trimmer 210 including a cutting board or base 212 with a cutting surface 214 upon which material to be cut is arranged. The material to be cut is placed in a slot or paper path 215 between surface 214 and a cutting assembly 225. The material can be arranged between a top end 216 of the cutting surface and a bottom end 218.

Cutting assembly 225 includes a bracket 226 and a trimmer assembly 250. Bracket 226 preferably has a top end 227 mounted to the top end 216 of trimmer 210 and bracket 226 has a bottom or lower end 228 mounted to lower end 218 of trimmer 210. Paper path 215 is defined between cutting surface 214 and the lower side of bracket 226. Trimmer assembly 250 is preferably mounted to bracket 226 and allowed to slidably reciprocate between the top and bottom ends of bracket 226 as desired. A rotary blade extends from trimmer assembly 250. In use, trimmer assembly 250 is pressed downward by the user to clamp the paper or cutting material between bracket 226 and cutting surface 214 while the trimmer assembly is slid along bracket 226 to the desired end of the cut. A self-healing strip (not visible) may be recessed in the base 212 to receive the lower edge of the blade during cutting.

As illustrated in FIG. 9, if a user desires to cut material piece 211 at an oblique angle to its edges, the user must manipulate the paper in an attempt to position the desired cut line along the trimmer blade's cutting path. Additionally, any grid lines (if present) may be of little or no value to the user when angling the paper oblique to the lines. This can prove challenging for the user, and can also lead to imprecision in the desired cut.

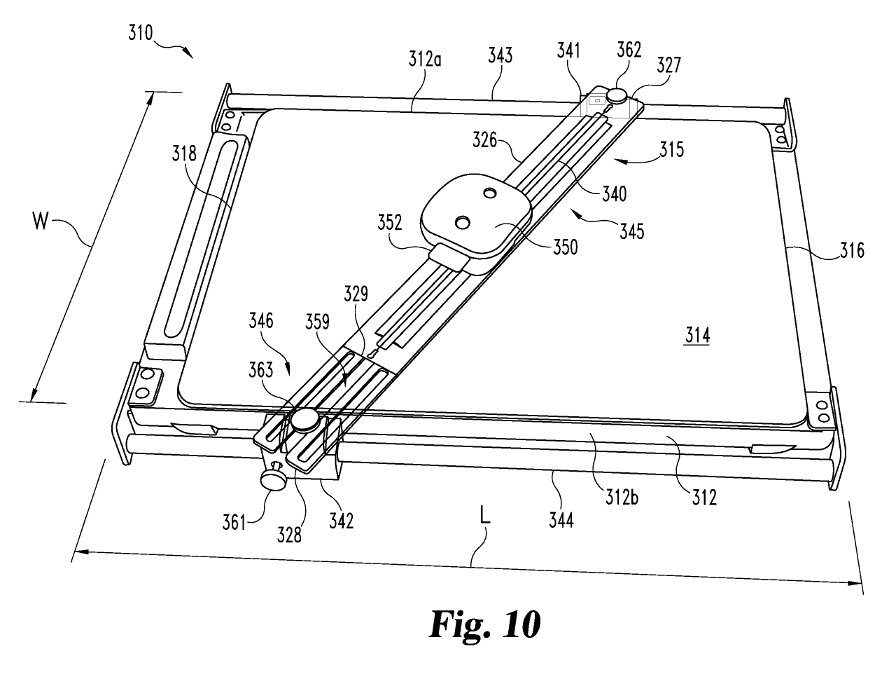

Rotary trimmer 310, as illustrated in FIGS. 10 through 12, includes a base 312 with a cutting surface 314 upon which a material to be cut is arranged, the base having a length L and a width W. The material to be cut is placed in a slot or paper path 315 between cutting surface 314 and a cutting assembly 325. The material is preferably arranged between the ends 316 and 318 of the cutting surface. Trimmer 310 includes a moveable cutting path assembly engaged with the base 312 as discussed below to provide cutting angle adjustability.

Cutting assembly 325 includes a bracket 326 and a trimmer assembly 350 allowed to slidably reciprocate along at least a portion of the bracket to cut the material positioned on surface 314. In the illustrated embodiment, bracket 326 has a first end 327 positioned adjacent an edge 312a of base 312 and engaged with a first sliding block 341, a second end 328 positioned adjacent an edge 312b of base 312 and engaged with a second sliding block 342. Bracket 326 includes a cutting portion 345 extending from first end 327 to a transition point 329, and a translation portion 346 extending from transition point 329 to second end 328.

Trimmer assembly 350 is preferably mounted to bracket 326 and allowed to slidably reciprocate between end 327 and transition point 329 as desired. In certain embodiments, trimmer assembly 350 is a blade housing from which a rotary blade extends. In use, trimmer assembly 350 may be pressed downward by the user to clamp the paper or cutting material between bracket 326 and cutting surface 314 while the trimmer assembly is slid along bracket 326 to the desired end of the cut. In certain embodiments, surface 314 may optimally have self-healing properties to reduce or eliminate any damage caused by the lower edge of the blade during cutting.

Blocks 341 and 342 are each configured to slide independently along rods or rails 343 and 344 along length L adjacent and slightly offset from edges 312a and 312b of base 312, respectively, with bracket 326 extending across the width W of base 312 above surface 314. In the illustrated embodiment, a user may independently slide the blocks along the rails to create the desired angled cutting path for the trimmer, eliminating the need to rearrange the paper on the cutting surface to align the desired cutting line on the paper with the cutting path of the trimmer. In this way, the user is able to arrange the cutting path of the trimmer at oblique angles to the sides of the cutting surface. This can be beneficial when an oblique angle cut is desired when cutting pictures or other materials, and/or when a partial cut in the material is desired.

In the illustrated embodiment, bracket 326 is engaged with blocks 341 and 342 via screws 362 and 363, respectively. In such embodiments, bracket 326 defines a hole adjacent first end 327 through which screw 362 is inserted. At the other end, bracket 326 defines a slot 359 in translation portion 346 through which screw 363 translates as bracket 326 is moved across surface 314. As the blocks are slid along the rails by the user, the more aligned the blocks are across the cutting surface from each other, the closer screw 363 will be to transition point 329, as opposed to end 328, and vice versa.

Once bracket 326 is positioned above surface 314 as desired, a user may selectively secure blocks 341 and 342 at their respective locations along rails 343 and 344 via a securement mechanism. In a particular embodiment, side screws 360 and 361 may be advanced prior to cutting the material to secure the position of the blocks 341 and 342. Securement of the blocks inhibits movement of the bracket away from the desired cutting line before the user cuts the material, or during the cutting process. However, it should be appreciated that the blocks can be secured at desired locations along the rails in other appropriate manners as would occur to one skilled in the art. As an example, the blocks could each include a lever clamp which can be engaged to temporarily fix the blocks at the desired locations, with the screws being absent. A user may also desire to secure bracket 362 with respect to blocks 341 and 342 to inhibit or prevent any slight movement of the bracket relative to the blocks. In such embodiments, screws 362 and 363 may be tightened to secure bracket 326 against blocks 341 and 342, respectively. After the desired cut is made, screws 360-363 may be loosened or backed-out to allow a user to freely slide the blocks along the rails to obtain the next desired angled cutting line on the material.

It should be appreciated that the illustrated embodiment having blocks slidable along rails is merely one example of numerous possible mechanisms to independently move ends of the bracket along sides of the cutting surface. As another example, the rotary trimmer could include grooves or gutters defined along the sides thereof with blocks, or other such appropriate pieces, independently slidable within the gutters to angle the bracket and cutting assembly as desired. Additionally, in the illustrated embodiment bracket 126 is clear or transparent to enable a user to see through the bracket to better align the desired cutting path over the material. However, it should be appreciated that in other embodiments the bracket may be opaque.

Trimmer assembly 350 may include a circular rotary blade with a straight edge; however, alternate blades can optionally be used instead. Examples include patterned, scalloped, pinking, waved, perforating or zigzag edged blades. In certain embodiments, trimmer assembly 350 can allow for ease of changing a desired blade in use. In one embodiment, the trimmer assembly includes a push button assembly to alternately select one of two available blades, while in other embodiments two or more blades may be available to be selectively engaged. In a still further embodiment, the trimmer assembly may allow for mounting of a blade cassette to interchangeably mount cassettes with different blades. As an optional feature, base 312, surface 314 and/or bracket rails 330 can optionally be marked with alignment lines and or measurements to assist in placing material to be cut. Such lines are not illustrated herein to facilitate ease of understanding the disclosure.

In certain embodiments, cutting assembly 325 may optionally include a line guide 340 which is visible during use to allow a user to precisely align a desired cut line in a material with a cutting path of the trimmer blade. Line guide 340 is mounted to bracket 326 and extends over paper path 315 so that the line guide 340 is visible over the material to be cut just prior to the cutting action.

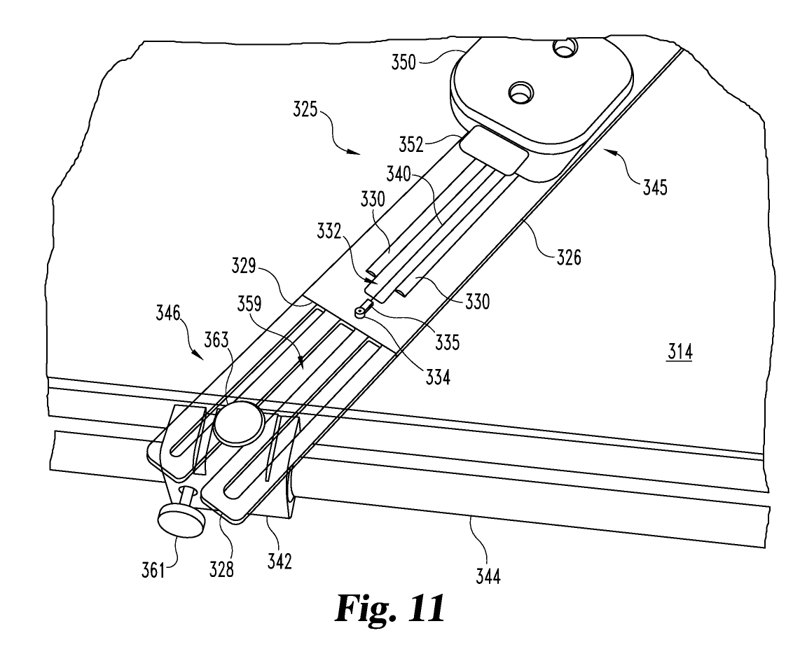

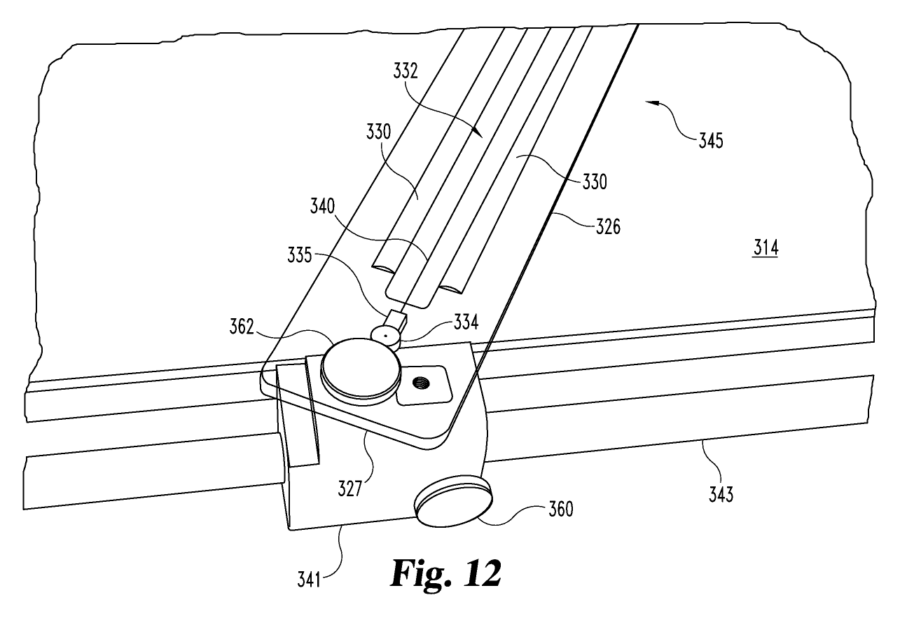

Close-up views of the ends of cutting assembly 325 according to certain embodiments are illustrated in FIGS. 11 and 12. In the illustrated embodiment, bracket 326 includes two substantially laterally rigid side or guide rails 330 defining a cutting slot 332 between them. In certain embodiments, the side rails 330 are parallel. Alternatively, the bracket 26 could include a single rail on which the cutting assembly 25 slideably reciprocates. Line guide 340 extends longitudinally along the bracket within the slot and is mounted to bracket 326 adjacent end 327 and transition point 329. Line guide 340 is spaced above surface 314, such that material can be positioned underneath line guide 340 and bracket 326 in paper path 315. One example of a mounting is a connector 335 with an eyelet mounted over a connector pin 334 on bracket 326 and a clamp holding the line guide material. Trimmer assembly 350 is preferably mounted to bracket 326 with a blade (not shown) extending into slot 332 and adjacent line guide 340. Trimmer assembly 350 may optionally include a handle portion 352 to be pressed downward by the user to push the trimmer along the bracket.

In embodiments having line guide 340, the line guide extends longitudinally within slot 332 to indicate the cutting path of the blade of the trimmer. As illustrated, line guide 340 may be spaced with gaps between it and side rails 330. The cutting blade is also spaced between the side rails as well. In such embodiments, the line guide can be considered independent from the side rails, defining a “floating” line. In alternate embodiments, line guide 140 may float over the paper with one rail or without rails so that the line guide is not part of or near a rigid rail type portion. In such embodiments, alternate mounting systems will be needed to hold and guide the trimmer assembly.

Line guides 40, 140 and/or 340 may be formed from a resilient, flexible material which can be deflected by the corresponding blades. In these embodiments, line guides 40, 140 and/or 340 are closely aligned adjacent the blade (or its cutting path, as in the case of line guide 140) and is resiliently pushed slightly sideways by the blade. In such embodiments, line guides 40 and 340 will remain in alignment with the cutting path in front of and behind the blade and line guide 140 will remain aligned with the cutting path of blade 130 ahead of the blade cutting the material. As such, a portion of line guide 140 is pushed aside by blade 130 so that portion is not precisely aligned with the cutting path, while blade 130 is. As blade 130 completes the cut of the material, nearly all of line guide 140 will be pushed aside from the cutting path by blade 130.

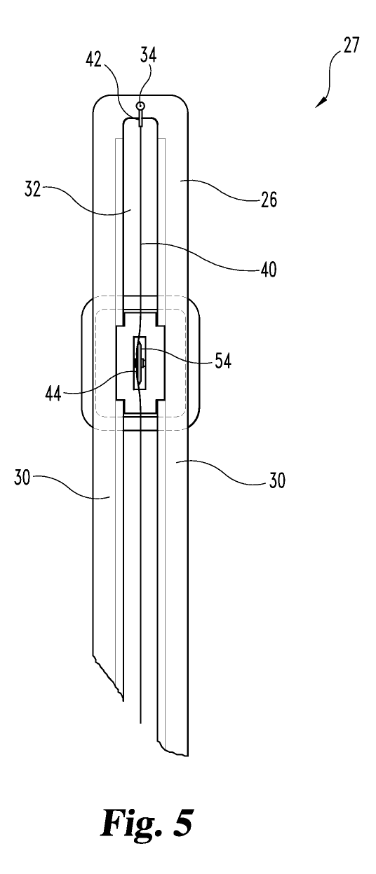

The flexible and pushed aside aspect of line guide 40 is illustrated in FIG. 5. FIG. 5 illustrates blade 54 from an underneath view. As illustrated, line guide 40 is aligned with the travel path of blade 54 within slot 32 in front of and behind blade 54. A portion 44 of line guide 40 adjacent 54 has been pushed aside by the blade so that portion 44 is not precisely aligned with the cutting path, while blade 54 is. Movement of trimmer assembly 50 and blade 54 along slot 32 will change which specific portion of line guide 40 is pushed aside. Similarly, a portion of line guide 340 adjacent the blade will be pushed aside by the blade so that portion is not precisely aligned with the cutting path, while the blade is. Movement of trimmer assembly 350 and the corresponding blade along slot 332 will change which specific portion of line guide 340 is pushed aside.

In certain preferred embodiments, line guides 40, 140 and/or 340 are made in a filament profile tautly held between the ends of slot 32, the ends 116 and 118, and the ends of slot 332, respectively. Examples of types of filament materials include metal wire, plastic or nylon wire or line or a similar material such as string or a cord. Preferably, the diameters of the line guides are minimized to more precisely indicate the cutting path while maintaining sufficient strength, flexibility and give to be pushed aside by the travel movement of the corresponding cutting blade and not cut. In contrast, brackets 26 and 326 and side rails 30 and 330 are preferably made from a more rigid material such as a hard plastic.

In certain embodiments, line guide 40 of rotary trimmer 10, line guide 140 of guillotine trimmer 110 and/or line guide 340 of rotary trimmer 310 may optionally be in a contrasting color or illuminated so that the line guide may be seen more easily and form a greater contrast to the cutting surface or material, thereby assisting the user in more precisely arranging the paper with the desired cutting path. Examples of highly contrasting colors would be fluorescent colors such as yellow, green or pink. Bright colors such as blue or red may alternatively be used.

In some embodiments, light is internally transmitted through line guides 40, 140 and/or 340 such that the line guide may be internally illuminated to internally reflect, transmit and emit light. In certain embodiments, line guides 40, 140 and/or 340 may project a line of light onto the material in the area to be cut, and in certain embodiments along a focused line aligned with the cutting path of the blade. Light sources may be arranged adjacent the top and bottom ends of line guides 40, 140 and/or 340 (and/or the top and bottom ends of the trimmer) to emit light directed along the line guide, with the line guide being composed of an electroluminescent, transparent and/or translucent material capable of illumination by the light sources. As an example, trimmer 10 may include one or more light sources arranged at both top and bottom ends 27 and 28, respectively, to illuminate line guide 40. As another example, trimmer 110 may include one or more light sources arranged on both top and bottom ends 116 and 118, respectively, to illuminate line guide 140.

In such cases, line guides 40, 140 and/or 340 may be formed of a material suitable for internal transmission of light such as a clear or translucent plastic, acrylic or glass. The line guides can be clear throughout or can be colored or masked in desired locations to control or focus the emission of light from the line guides. Full or partial masking may be used to control and define the light emission path. If desired, the line guides can be configured to emit light in alternate shapes to assist a user, such as parallel lines, lines with cross-hatches for measurement or dotted or partial lines. Additionally, the line guides can be in various geometries to control light emission such as circular or rectangular according to the cross-sections of the line guides. Additionally, line guides 40, 140 and/or 340 may be designed with a contrasting color such as orange or yellow or green which is additionally highlighted by the illumination of the line guide.

In certain embodiments, one or more light sources provide light output directed into or onto the line guides for transmission and illumination. The trimmers may include switches thereon which are controllable by a user to turn the light sources on or off. In some embodiments, at least one and preferably a plurality of LED's are arranged to provide light to line guides 40, 140 and/or 340. A power source preferably supplies power to the light sources, such as batteries mounted in the trimmers or a power cord connectable to the trimmers.

If illumination is desired, line guides 40, 140 and/or 340 may be formed of a transparent or translucent material suitable for internally reflecting, transmitting and emitting light received into the material. The material may preferably be shaped or treated to control the portions which emit light in desired locations. LED's are often a preferred light source for minimal heat and power yet provide significant illumination. However, alternate light sources such as incandescent or fluorescent lamps or a laser can be alternately used. It is contemplated that other appropriate light sources may be used to transmit light into or onto the line guides. In certain embodiments, one or more fiber optic cables carry light and emit it either at ends or laterally at desired locations along the length of the line guides.

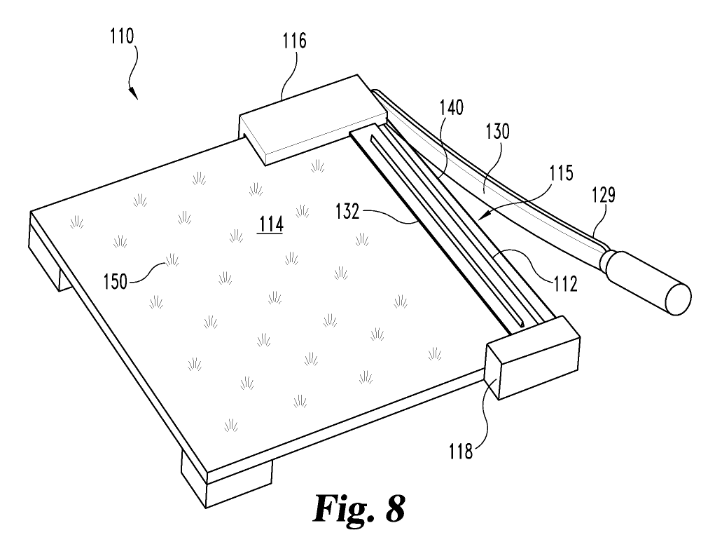

In certain embodiments, cutting surface 14 of rotary trimmer 10, surface 114 of guillotine trimmer 110 and/or surface 314 of rotary trimmer 310 may optionally be in a contrasting color or illuminated so that the surfaces can be seen more easily through and form a greater contrast with the material to be cut or the cutting path of the blades to assist the user in more precisely arranging the paper with the desired cutting path. As an example, FIG. 8 shows guillotine trimmer 110 with surface 114 being illuminated, as illustrated by light effects 150. In certain embodiments, the surface(s) is a light transmissive surface such that the illumination provides light up through the surface which can be seen through paper positioned on the surface to be cut. The illumination up through the paper assists the user in aligning the paper as desired to obtain the desired cut.

In certain embodiments where surfaces 14, 114 and/or 314 includes grid lines to assist the user in aligning the material, illumination of the surfaces allows the grid lines to be seen more easily. In certain embodiments, the surfaces may be illuminated with a substantially bright and contrasting color, such as yellow, green, blue, turquoise or orange as examples. In such cases, the surfaces may be formed of an electroluminescent material of a desired color such that light emitted from the light sources creates illumination in the bright and contrasting color. Alternatively, the surfaces may be clear, with colored light sources arranged to emit the desired color light through or onto the clear surfaces to create the colored illumination. In other embodiments, the surfaces may be illuminated with a traditional white lighting color.

As an example configuration, surfaces 14, 114 and/or 314 may be composed of a transparent or translucent material, with masking applied to the bottom and an end surface of the material leaving the top surface un-masked to encourage or focus light emission up through the surfaces. LED's may be arranged at the un-masked end of the material to emit light through the transparent or translucent material, illuminating the surfaces.

Additionally, the self-healing strip of trimmer 10 which receives the lower edge of the rotary blade of trimmer assembly 10 may also be in a contrasting color or illuminated so that the strip and the cutting path can be seen more easily. The illumination (or contrasting color) of the self-healing strip of trimmer 10 may be in addition to or in lieu of the illumination (or contrasting color) of surface 14. The self-healing strip may be illuminated through a variety of possible illumination mechanisms, many of which are discussed above in connection with surfaces 14 and/or 114.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed is:

1. A rotary trimmer apparatus, comprising:
a base;
a bracket engaged with the base, wherein the bracket includes two parallel side rails defining a central cutting slot between the rails, wherein the bracket is spaced above the base to define a gap therebetween to allow material to be inserted into the gap;
a trimmer assembly engaged with the bracket and slideable along the side rails, wherein the trimmer assembly includes a cutting blade extending down into the central cutting slot to cut material positioned in the gap; and
a line guide portion engaged with the bracket to extend along the central cutting slot between the rails to indicate the cutting path of the cutting blade.

2. The apparatus of claim 1, wherein the line guide portion is a filament held taut along the central cutting path.

3. The apparatus of claim 2, wherein the line guide portion is composed of a filament material selected from the group consisting of metal, plastic and nylon.

4. The apparatus of claim 1, wherein the bracket includes opposing top and bottom end portions, with the trimmer assembly configured to reciprocate between the end portions.

5. The apparatus of claim 4, wherein the line guide portion includes opposing top and bottom ends mounted to the top and bottom end portions of the bracket.

6. The apparatus of claim 1, wherein the line guide portion is centrally positioned between the side rails.

7. The apparatus of claim 1, wherein the line guide portion is configured to emit illumination.

8. The apparatus of claim 7, wherein the line guide includes at least partial masking to control the illumination.

9. The apparatus of claim 1, wherein the base includes a light transmissive cutting surface configured to be upwardly illuminated

10. A trimmer apparatus, comprising:
a base having a top surface;
a cutting assembly engaged with the base, wherein the cutting assembly includes a blade moveable with respect to the base along a cutting path; and
a flexible and resilient line guide positioned along the cutting path to provide a visual indication of the cutting path of the blade.

11. The apparatus of claim 10, wherein the line guide is a tautly-held filament.

12. The apparatus of claim 10, wherein the line guide is configured to emit illumination.

13. The apparatus of claim 10, wherein the base includes a longitudinal cutting edge and the cutting assembly includes a guillotine handle pivotally mounted adjacent the longitudinal cutting edge of the base, the handle including the blade, and wherein the line guide is coupled to the base and spaced above the top surface so that material to be cut can be positioned underneath the line guide.

14. The apparatus of claim 10, wherein the cutting assembly includes a bracket engaged with the base, wherein the bracket includes two parallel side rails defining a central cutting slot between the rails, the bracket being spaced above the base to define a gap therebetween to allow material to be inserted into the gap, wherein the cutting assembly includes a blade housing engaged with the bracket and slideable along the side rails, the blade extending down into the central cutting slot to cut material positioned in the gap.

15. The apparatus of claim 14, wherein the line guide is engaged with the bracket to extend along the central cutting slot between the rails.

16. A rotary trimmer apparatus having a movable cutting path, comprising:
a base having a top cutting surface, the base having first and second opposing longitudinal sides;
a moveable cutting path assembly engaged with the base, wherein the assembly includes a first end portion moveable adjacent and parallel to the first longitudinal side and a second end portion moveable adjacent and parallel to the second longitudinal side, the end portions being movable independent of each other, wherein the assembly includes at least one guide rail extending at least partially between the end portions, wherein the at least one guide rail is spaced above the top cutting surface to define a gap therebetween to allow material to be inserted into the gap; and
a trimmer assembly engaged with the moveable cutting path assembly and slideable along the at least one guide rail, wherein the trimmer assembly includes a cutting blade to cut material received in the gap along a cutting path;
whereby movement of at least one of the end portions causes the at least one guide rail to move above the cutting surface, thereby moving the cutting path of the cutting blade.

17. The apparatus of claim 16, wherein each of the end portions includes a securement mechanism configured to be selectively engaged to secure the position of the end portion with respect to the base at a desired location.

18. The apparatus of claim 16, further comprising a flexible and resilient filament line guide coupled to the moveable cutting path assembly and extending at least partially between the end portions along the cutting path of the cutting blade, the line guide being offset from the at least one guide rail spaced above the cutting surface.

19. The apparatus of claim 16, wherein the moveable cutting path assembly includes a bracket engaged with the end portions, the bracket having the at least one guide rail, wherein the at least one guide rail includes two parallel side rails defining a central cutting slot between the rails, the cutting blade extending down into the central cutting slot to cut material positioned in the gap.

20. The apparatus of claim 19, further comprising a filament line guide engaged with the bracket to extend along the central cutting slot between the rails to indicate the cutting path of the cutting blade.
